(19) United States
(12) Patent Application Publication
(10) Pub. No.: US 2004/0187318 A1
(43) Pub. Date: Sep. 30, 2004

(54) Rotary trimmer

(75) Inventors: David Mathieu, South Glastonb, CT (US); Marta Phillips, Fairfield, CT (US); Jim Sener, Glastonbury, CT (US)

Correspondence Address: Charles N.J. Ruggiero, Esq., Ohlandt, Greeley,, Ruggiero & Perle, L.L.P., One Landmark Square, 10th Floor, Stamford, CT, 06901-2682, US

(73) Assignee: ACME UNITED CORPORATION

(21) Appl. No.: 10/695,429

(22) Filed: Oct. 28, 2003

Related U.S. Application Data
(60) Provisional application No. 60/421,581, filed on Oct. 28, 2002.

(51) Int. Cl. B26B 3/00

(52) U.S. Cl. 30/319

(57) ABSTRACT

There is provided a rotary style trimmer that has a blade carriage for carrying one or more interchangeable cutting blades. The blade carriage has a connector for enabling the blade carriage to be connected to a guide rail, a handle that enables an operator to manipulate and/or guide the one or more cutting blades, and a guard for at least partially covering at least one of the cutting blades. When a new and/or different blade is desired, the entire blade-guard assembly is removed and replaced thereby providing improved safety.

### BACKGROUND OF THE INVENTION

1. Field of the Invention

The present invention relates generally to rotary trimmers. More particularly, the present invention relates to a versatile rotary trimmer with interchangeable blades.

2. Description of the Prior Art

A rotary trimmer is a device by which paper, cloth, and wallpaper or like materials may be cut to a specific shape or size as determined by the operator. The rotary trimmers that are known in the art are often permanently connected to cutting boards. These cutting boards typically include a base with a planar surface for supporting the material to be cut, a measuring tool for measuring the length and width of the material, and a cutting guide or guide rail for guiding the rotary trimmer along a predefined path.

Conventional rotary trimmers have a blade holding portion for rotatably mounting or holding a circular one or more cutting blades and handle portion for allowing a user to guide the one or more circular cutting blades along a cut pattern. The circular cutting blades are typically mounted in the blade holder such that in an operative state the blades freely rotate during interaction with the material to be cut and in an inoperative state the blades are safely stored.

Conventional rotary trimmers typically require the operator to apply a downward pressure to the blade holder to bias the circular cutting blades to the cutting surface. It is difficult for an operator to apply a smooth even cutting stroke when pushing both downward only. Thus, the material to be cut may be poorly or unevenly cut. A need exists for a versatile rotary trimmer that overcomes this noted shortcoming.

Conventional rotary trimmers may also have interchangeable blades. Changing the trimmer blade alone has historically been a difficult and dangerous operation, as the operator is required to handle the bare blade to lock the blade to the carriage assembly. A need therefore exists for a versatile rotary trimmer device that avoids the risk of personal injury inherent to conventional rotary trimmers.

### SUMMARY OF THE INVENTION

It is an object of the present invention to provide a versatile rotary trimmer that effectively and efficiently provides for a smooth and even cutting stroke.

It is another object of the present invention to provide a versatile rotary trimmer that can selectively cooperate with a separate biasing element that is associated with a cutting board.

It is still another object of the present invention to provide a versatile rotary trimmer that can pivotally cooperate with a cutting guide that is associated with a cutting board.

It is yet another object of the present invention to provide a versatile rotary trimmer that has an elongated handle.

It is yet still another object of the present invention to provide a versatile rotary trimmer that has an actuator in a handle for moving a cutting blade along a linear path between an inoperative position and an operative position.

It is a further object of the present invention to provide a versatile rotary trimmer that has interchangeable/disposable blades in a blade guard, whereby both the blade and blade guard are changed when a new blade is desired.

It is still a further object of the present invention to provide a blade guard that protects the operator from exposure to the circular cutting blade during the changing/replacement thereof.

It is yet a further object of the present invention to provide a blade carriage that facilitates lifting a cutting blade from a cutting surface by an angled movement.

These and other objects and advantages of the present invention are achieved by the rotary style trimmer of the present invention. The rotary trimmer of the present invention essentially has a blade carriage for carrying one or more interchangeable cutting blades. The blade carriage can have a connector to enable the blade carriage to be connected to a guide rail. The blade carriage can have a handle that enables an operator to manipulate and/or guide the one or more cutting blades. The blade carriage can also have a guard to at least partially cover at least one cutting blade so that when a new and/or different blade is desired the entire blade-guard assembly is removed and replaced to provide improved safety.

The interchangeable cutting blades are preferably circular and have a cutting edge with a predefined cutting profile (e.g., a wave profile, a scalloped profile, a volcano profile, a bowtie profile, etc). The cutting profile is preferably equally extensive with respect to opposing sides of a central planar side portion of the cutting blade. The central side portion also has one or more apertures to enable the blades to be mounted on a hub associated with the blade carriage. The blade carriage can be operatively connected to a cutting board via a guide rail.

### BRIEF DESCRIPTION OF THE DRAWINGS

The foregoing and still other objects and advantages of the present invention will be more apparent from the following detailed explanation of the preferred embodiments of the invention in connection with the accompanying drawings.

FIG. 1 is a perspective view of a rotary trimmer assembly in accordance with a preferred embodiment of the present invention, with a blade carriage connected to a rail;

FIG. 2 is a side view of the blade carriage of FIG. 1 in accordance with another embodiment of the present invention;

FIG. 3 is an end view of the blade carriage of FIG. 2;

FIG. 4 is a side section view of a blade carriage in accordance with another embodiment of the present invention;

FIG. 5 is an exploded view of the blade carriage of FIG. 4;

FIG. 6 is perspective view of a blade-guard assembly in accordance with an embodiment of the present invention;

FIG. 7 is perspective view of a cutting blade in accordance with an embodiment of the present invention;

FIG. 8 is an exploded perspective view of a rail assembly in accordance with an embodiment of the present invention;

FIG. 9 is an end section view of the rail assembly of FIG. 8;

FIG. 10 is an enlarged view of a segment of a biasing element in accordance with another embodiment of the present invention;

FIG. 11 is an end view of a connector in accordance with another embodiment of the present invention;

FIG. 12 is a side view of the connector of FIG. 11;

FIG. 13 is an end view of the connector of FIG. 11 in accordance with an alternative embodiment of the present invention;

FIG. 14 is a side view of the connector of FIG. 13;

FIG. 15 is a side view of the rail assembly of FIG. 8 in accordance with another embodiment of the present invention with the blade, via the blade carriage, in an inoperative position;

FIG. 16 is a side view of the rail assembly of FIG. 8 in accordance with another embodiment of the present invention with the blade, via the blade carriage, in an operative position;

FIG. 17 is perspective view of an alternative embodiment of the present invention, showing the rail assembly connected to a cutting board via a single pivot point and the cutting board with a storage tray;

FIG. 18 is a perspective view of another embodiment of the present invention, showing a cutting board with an adjustable cutting surface;

FIG. 19 is a perspective view of still another embodiment of the present invention, showing the rail assembly connected to a cutting board via a single pivot point and the cutting board with blade-guard assembly storage bays;

FIG. 20 is a perspective view of yet another embodiment of the present invention, showing a cutting board with a removable and/or replaceable cutting surface;

FIG. 21 is a perspective view of still yet another embodiment of the present invention, showing a cutting board supported on its end in a storage position via the rail assembly; and

FIG. 22 is a perspective view of a further embodiment of the present invention, showing a magnetic storage tray.

### DETAILED DESCRIPTION OF THE INVENTION

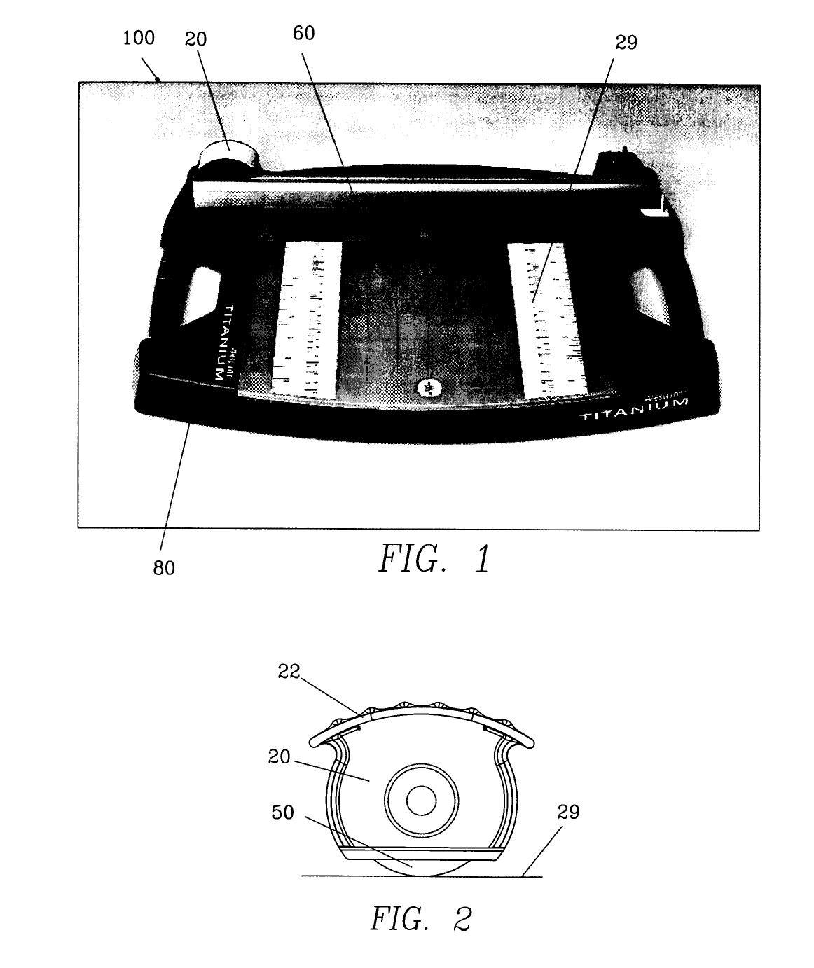

Referring to the drawings and in particular FIGS. 1 and 2, there is provided a rotary style trimmer according to the present invention, generally represented by reference numeral 100. The rotary trimmer 100 has a blade carriage 20 for interchangeably carrying one or more cutting blades 50. Blade carriage 20 can be connected to a guide rail 60. The guide rail 60 is preferably pivotally mounted to a cutting board 80 and provides a surface along which the blade carriage 20 can slide. The guide rail 60 is preferably extruded.

In a preferred aspect of the present invention, shown in FIG. 2, blade carriage 20 can have a handle 22. The operator can use handle 22 to manipulate and/or guide one or more cutting blades 50 when operatively connected to blade carriage 20. Handle 22 can take any of a variety of different forms. For example, as shown in FIG. 2, handle 22 can be an arcuate palm pad. In another aspect of the present invention, shown in FIG. 4, handle 22 can be elongated and have hand grip portion 24 with a neck 26 that connects grip portion 24 to blade carriage 20.

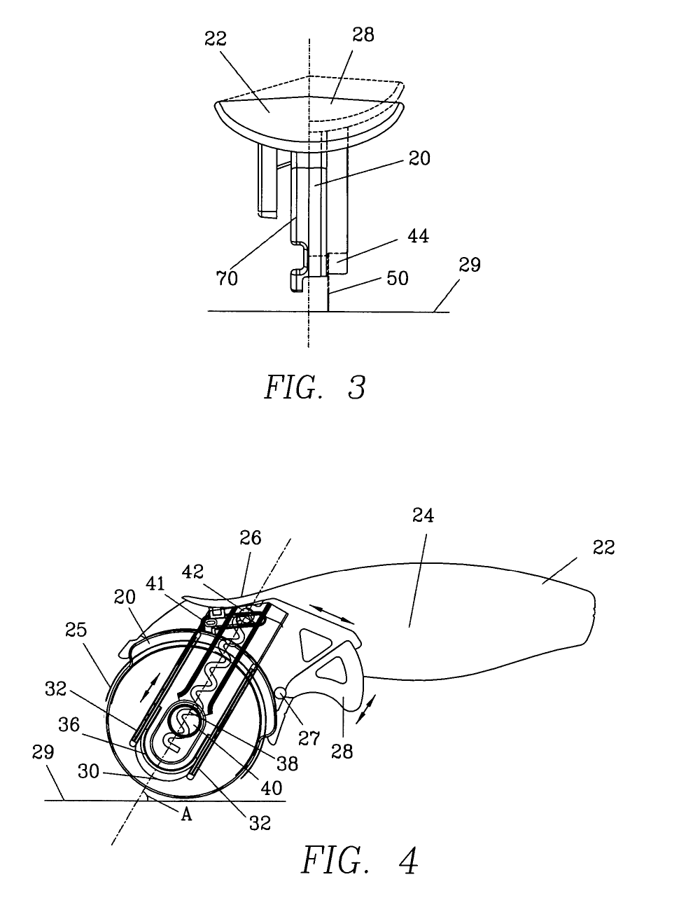

Referring to FIGS. 3 and 4, handle 22 may also have an actuator 28 for selectively positioning cutting blades 50 with respect to a cutting surface 29. Actuator 28, like handle 22, can take any of a variety forms. For example, as shown in FIG. 2, actuator 28 can be integral with blade carriage 20 such that a portion thereof can move to position cutting blade 50 with respect to a cutting surface 29. In another aspect of the present invention, actuator 28 can be a squeeze trigger, as shown in FIG. 3.

Actuator 28 can preferably move and/or position cutting blades 50 along a linear path 30, shown in FIG. 4. The linear path 30 preferably is defined by one or more channels 32 in blade carriage 20 and preferably oblique or angled with respect to the cutting surface 29 during use.

As shown in FIG. 4, actuator 28 preferably cooperates with a slide mount assembly 34 that is in blade carriage 20. Slide mount assembly 34 preferably has a sliding plate 36, a biasing member 38, a mounting post 40 and a connecting pin 42. Sliding plate 36 is preferably shaped to operatively engage channels 32 of blade carriage 20 to slide along the linear path 30 defined by channels 32. Biasing member 38 preferably interacts with both sliding plate 36 and channels 32 to provide a predefined bias to sliding plate 36. Mounting post 40 preferably is connected to sliding plate 36 and can carry cutting blades 50. Connecting pin 42 is preferably also connected to sliding plate 36 and connects actuator 28 to sliding plate 36 and/or biasing member 38 so that the predefined bias of sliding plate 36 provided by biasing member 38 can be overcome by a user or operator acting on actuator 28.

That is, the operator can engage actuator 28 by a squeezing action. This squeezing action or motion is preferably translated, by connecting pin 42 and/or biasing member 38, to a linear force that acts on sliding plate 36. Preferably, this linear force is preferably sufficient to overcome the predefined bias of bias member 38 and cause sliding plate 36 to move. Preferably, this sliding movement of sliding plate 36 facilitates cutting blade 50, which is preferably carried by mounting post 40, may be selectively positioned into any of a variety of positions with respect to blade carriage 20 and/or cutting surface 29. It should be understood that other configurations and/or arrangements may also be used to effectuate the selective linear positioning of cutting blade 50.

As clearly shown in FIG. 4, it is significant that linear path 30 is oblique or angled, at a predefined angle A, with respect to a cutting surface 29 during operative use. This orientation preferably facilitates achieving a more ergonomic cutting operation and a smooth, consistent cutting stroke by translating the downward pressure provided by the operator into both a downward and forward pressure.

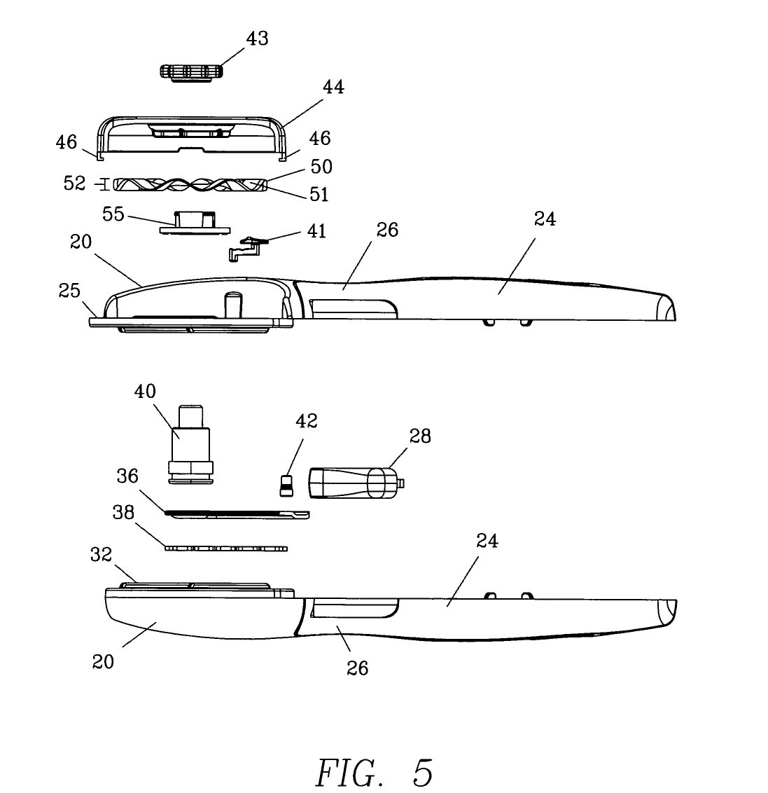

In another aspect of the present invention shown at least in FIGS. 3, 5 and 6, blade carriage 20 can have a blade guard 44. Guard 44 can at least substantially house or cover cutting blades 50 to preferably provide a protective barrier that protects the operator from direct exposure to cutting blade 50. Guard 44 can be connected, preferably detachably, to blade carriage 20 by one or more fasteners, such as, for example, the retention snaps 46 shown in FIG. 5. Alternately, guard 44 and/or respective cutting blade 50 may be connected to blade carriage 20 by a threaded connection using nut 43 and/or one or more bolts or screws. Other connectors may be used as appropriate to facilitate the objects of the present invention.

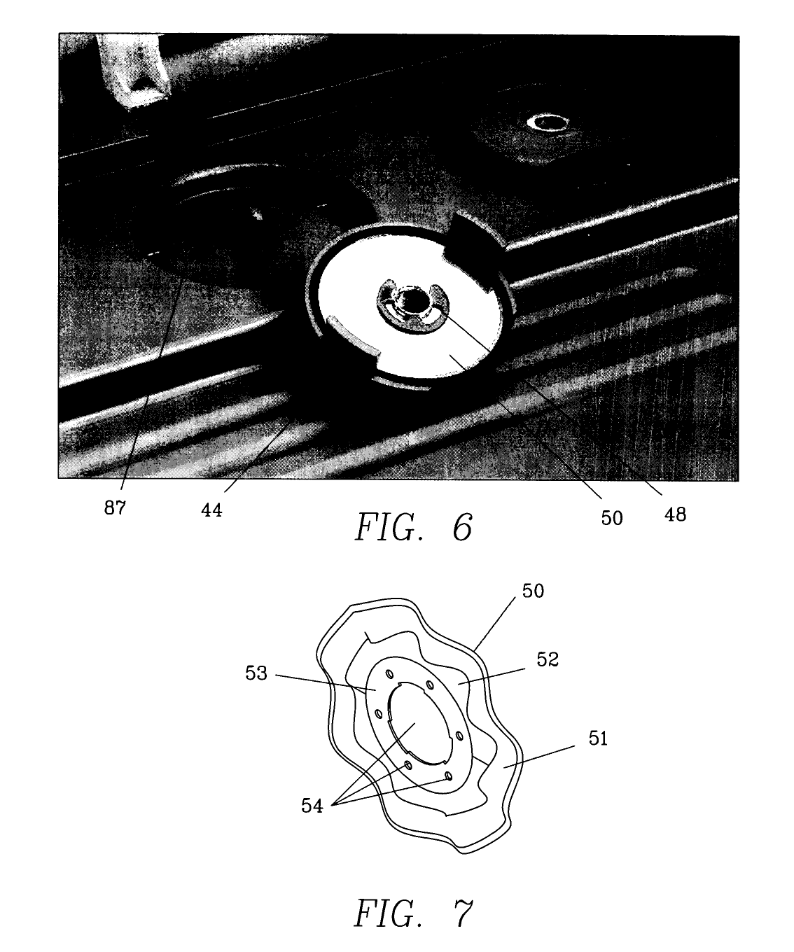

Guard 44 can be connected to at least one cutting blade 50 to form an integral blade-guard assembly. As shown in FIG. 6, the cutting blade 50 can be secured to guard 44 by a clip 48, or by any other suitable way, to form a single integral piece, so that when a new and/or different cutting blade 50 is desired the entire blade-guard assembly is removed and replaced on blade carriage 20. Accordingly, the operator is never directly exposed to cutting blade 50.

Cutting blade 50 can have any of a variety of shapes, sizes and/or configurations to provide a variety of different cutting operations. For example, as shown in FIG. 7, cutting blade 50 can be circular and have a cutting edge 51 with a predefined cutting pattern or profile 52 (e.g., a wave profile, a scalloped profile, a volcano profile, a bowtie profile, etc) that is preferably equally extensive with respect to planar side portion 53 of the cutting blade 50. Cutting blade 50 can also have one or more apertures 54 therein for cooperating with a mounting structure associated with blade carriage 20 and/or guard 44 (e.g., mounting post 40). Each cutting blade 50 can also have a hub 55 (shown in FIG. 5) connected thereto or integrally formed therewith. Hub 55 can preferably improve the structural integrity of cutting blades 50 and/or facilitate an effective the connection of cutting blade 50 to blade carriage 20 and/or guard 44. Apertures 54 and/or hub 55 of each cutting blade 50 can be configured to only connect to, and/or effectively operate with, a matching correspondingly configured mounting structure.

As previously mentioned, in a preferred embodiment of the present invention, blade carriage 20 can be operatively connected to cutting board 80 via rail 60. Rail 60 may be securely and/or pivotally mounted to cutting board 80. The pivotal movement of rail 60 preferably allows the operator optimal viewing for accurate placement of the material to be cut.

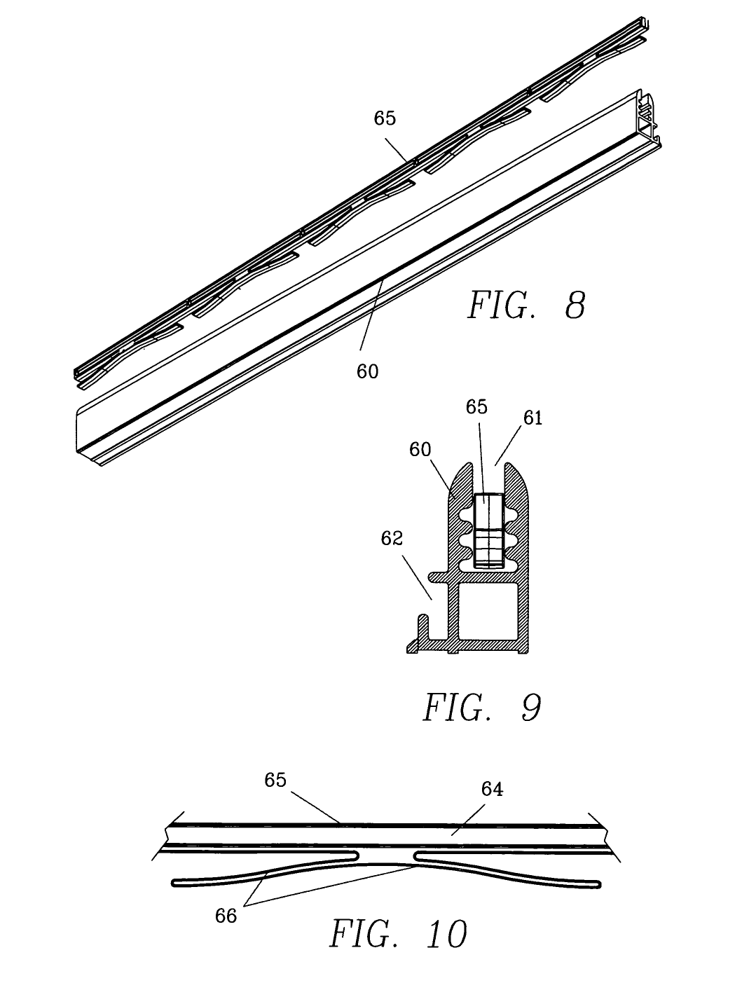

Referring to FIGS. 8 through 14, rail 60 can have one or more grooves 61, 62, at least one of which preferably has a biasing element 65 located therein. Biasing element 65 preferably acts on blade carriage 20, when connected to rail 60, to influence the disposition of cutting blade 50 with respect to the cutting surface 29 and to 67 provide for a smooth cutting stroke. Biasing element 65, as best shown in FIGS. 8 to 10, preferably takes the form of an elongated beam 64 with one or more flexible members 66 extending therefrom. Flexible members 66, although shown in the form of a pair of integral flat springs, may take any of a variety of different forms.

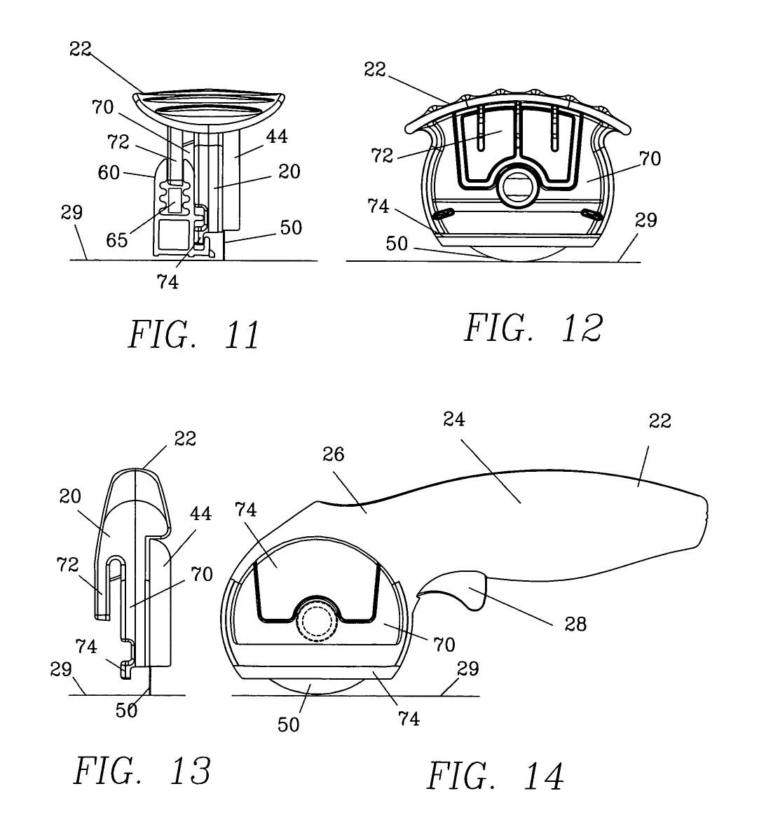

Referring more particularly to FIGS. 11 and 12, blade carriage 20 can have a connector 70 for connecting blade carriage 20 to rail 60. Connector 70 can, for example, have a guide rib 72 and a slide 74 (shown in FIGS. 13 and 14 in another aspect of the present invention). As shown best shown in FIG. 9, rail 60 can have a top guide groove 61 and a side guide groove 62. When connected to rail 60, blade carriage 20 can preferably ride or slide along rail 60 via slide 74 that preferably engages side guide groove 62. Guide rib 72, in turn, can preferably interact with biasing member 38, which is preferably disposed in top guide groove 61. Accordingly, the operator can position blade carriage 20 to an operable position for cutting by applying outward pressure to handle 22, thereby compressing biasing element 65 in the top guide groove 61, and/or actuating actuator 28 to cause cutting blades 50 to engage the cutting surface 29 and/or the material to be cut, preferably at an angle with respect thereto.

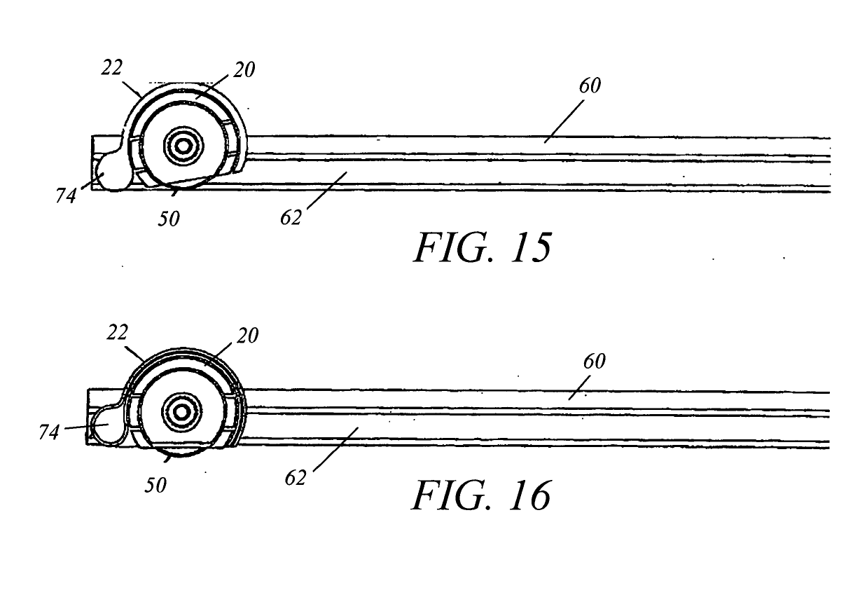

It is noted that connector 70 can have any of a variety of other configurations, for example, connector 70 can facilitate blade carriage 20 being removably connected to rail 60. Also, as shown in FIGS. 15 and 16, connector 70 can facilitate blade carriage 20 being pivoted with respect thereto. This may be accomplished in a variety of different ways. For example, blade carriage 20 can pivot about slide 74, within side guide groove 62, between an operable or blade lowered position shown in FIG. 16 and an inoperable position or blade raised position shown in FIG. 15. Thus, the operator can pivotally position blade carriage 20 to an operable position for cutting by applying a downward and forward pressure to handle 22, thereby compressing biasing element 65 in top guide groove 61, and pivoting blade carriage 20 about slide 74, within side guide groove 62.

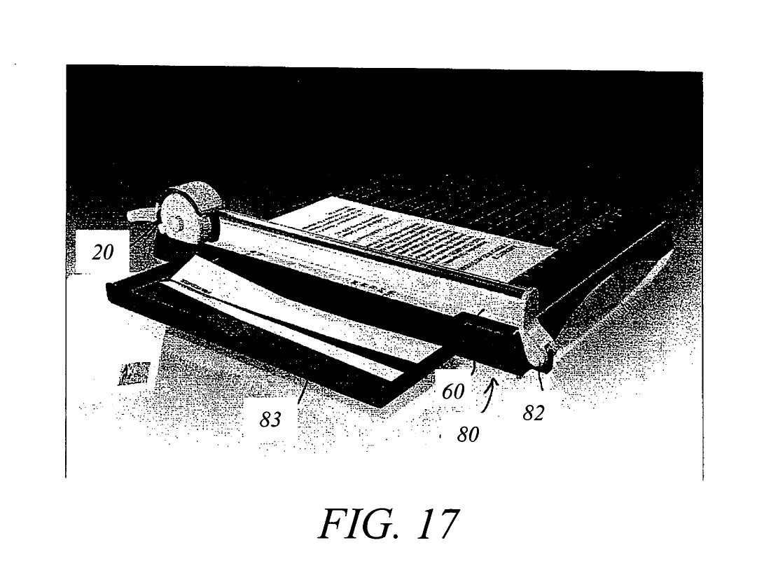

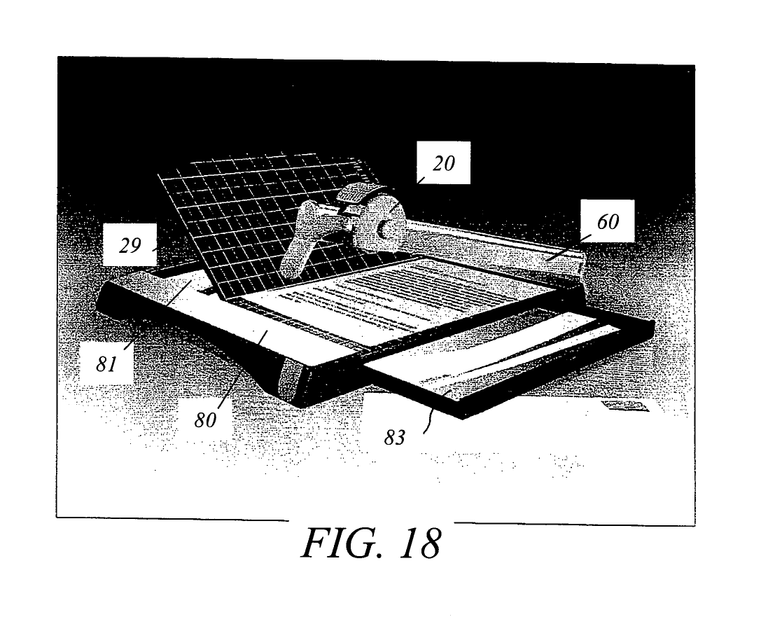

Referring to FIGS. 17 through 22, rail 60 may have one or more points of pivotal contact. For example, as shown in FIG. 17, rail 60 may pivot around a single pivot point 82 optimally located on cutting board 80. Rail 60 along with a connected blade carriage 20 may be lifted to a raised position, shown in FIG. 18, or may be lowered and locked to cutting board 80, as shown in FIG. 17. The way in which rail 60 is locked may be varied. Preferably, a male/female type connector, which can also serve to maintain rail 60 in alignment with cutting board 80 is used.

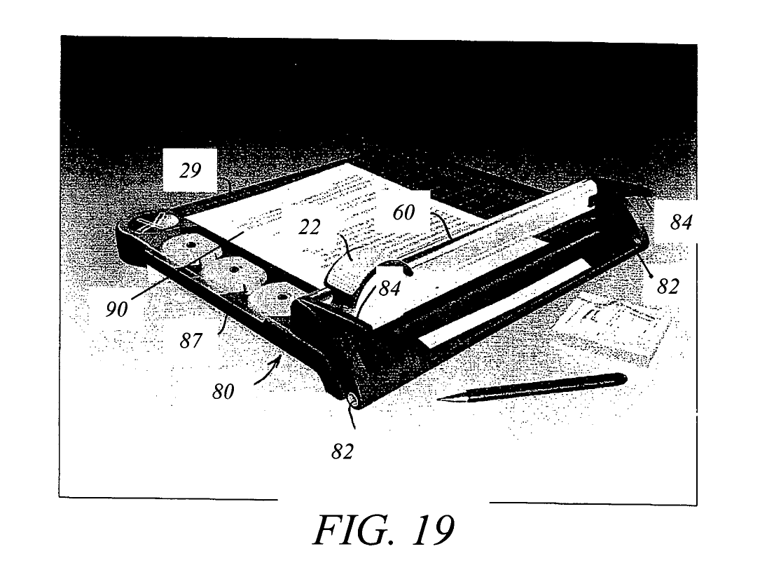

As alternatively shown in FIGS. 19 to 22, rail 60 can be pivotally mounted to cutting board 80 via two pivot points 82 optimally situated on cutting board 80. Again, as with the single pivot configuration, rail 60 can be raised from or lowered to cutting board 80 via pivotal movement about the two pivot points.

Referring again to FIG. 17, cutting board 80 of the present invention may have a storage bin 83 for storing blade carriage 20, cutting blades 50, guards 44, paper and/or similar materials.

Referring to FIG. 18, the entire cutting board 80, or any portion thereof, may be hingedly moved, and thus raised, to allow storage in a recessed space 81 in cutting board 80.

Referring to FIGS. 19 through 22, one or more guards 44 may be snapped, for example, by fasteners 46 into one or more storage bays 87.

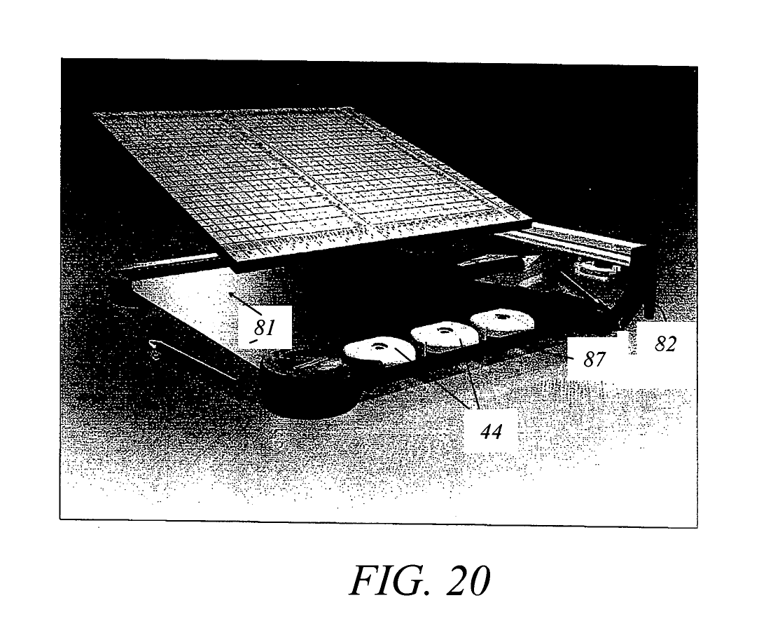

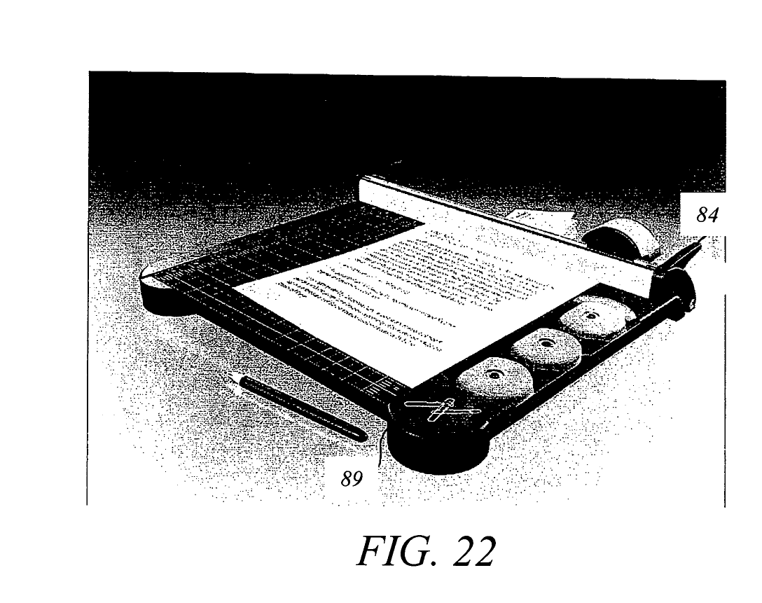

Referring to FIG. 20, cutting board 80 can be interchangeable with respect to rail 60. For example, cutting board 80 can be removable, reversible, or replaced entirely with different measuring devices or surface materials. As shown in FIGS. 22 to 24, cutting board 80 can be foldable for portability and storage. For example, two separate, hinged portions of cutting board 80 can be folded one upon the other to reduce the size of the cutting board.

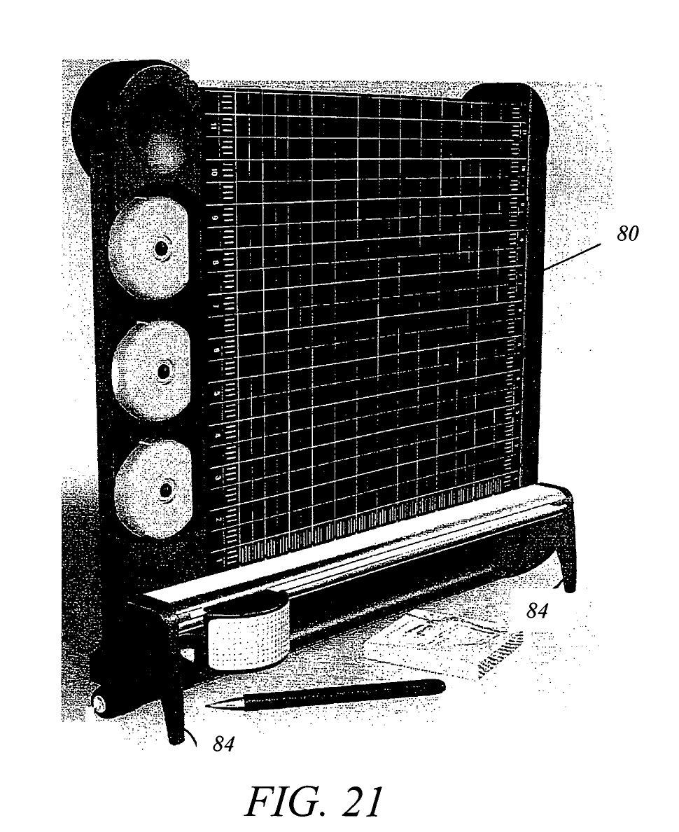

Referring to FIG. 21, rail 60 can have one or more projecting arms 84. As shown, rail 60 and arms 84 can cooperate to form a base support for cutting board 80 when in a stored upright position.

Referring to FIG. 22, any embodiment of the present invention may have a magnetized paper clip tray 89 for safe storage of paper clips in cutting board 80 of the trimmer.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the present invention.

What is claimed is:

1. A rotary trimmer comprising:
one or more cutting blades;
a blade carriage for carrying said one or more cutting blades; and
a rail having one or more guide grooves and being operatively connected to a cutting board, said rail having a biasing member in at least one of said one or more guide grooves,
wherein said blade carriage is operatively connected to said rail by said one or more guide grooves, and
wherein said biasing member is connected to said blade carriage so that a force on said blade carriage influences the position of said one or more cutting blades with respect to said cutting board.

2. The rotary trimmer of claim 1, further comprising a blade guard for protecting an operator from direct exposure to said one or more cutting blades.

3. The rotary trimmer of claim 2, wherein said blade guard has one or more fasteners for connecting said blade guard to said blade carriage.

4. The rotary trimmer of claim 3, wherein said one or more fasteners detachably connect said blade guard to said blade carriage.

5. The rotary trimmer of claim 3, wherein said blade guard and said one or more cutting blades are connected so that said blade guard can be used to safely remove and replace said one or more cutting blades with respect to said blade carriage.

6. The rotary trimmer of claim 5, wherein said cutting board has one or more storage compartments for storing one or more of said integral blade-guard assemblies.

7. The rotary trimmer of claim 2, wherein said blade guard and said one or more cutting blades are connected to form an integral blade-guard assembly.

8. The rotary trimmer of claim 1, wherein said biasing member is an elongated beam with one or more flexible arms connected thereto.

9. The rotary trimmer of claim 8, wherein said one or more flexible arms are integral to said biasing member.

10. The rotary trimmer of claim 1, wherein each of said one or more cutting blades has a cutting edge with a predefined cutting profile, a planar side portion with one or more apertures therein, and a transition portion between said profiled cutting edge and said planar side portion, said profiled cutting edge being equally extensive with respect to said planar side portion.

11. The rotary trimmer of claim 1, wherein said blade carriage is pivotally connected to said rail.

12. The rotary trimmer of claim 11, wherein said rail is extruded.

13. The rotary trimmer of claim 1, wherein said blade carriage slides along said rail.

14. The rotary trimmer of claim 1, wherein said rail is pivotally connected to said cutting board about a single pivot point.

15. The rotary trimmer of claim 1, wherein said rail is pivotally connected to said cutting board by two aligned pivot points.

16. The rotary trimmer of claim 1, wherein said cutting board has one or more storage compartments for storing said one or more cutting blades.

17. The rotary trimmer of claim 1, wherein said cutting board has interchangeable cutting surfaces.

18. The rotary trimmer of claim 1, wherein said cutting board is foldable for portability and storage.

19. A rotary trimmer comprising:
a blade carriage having a handle and an actuator; and
one or more cutting blades,
wherein said handle enables a user to effectively manipulate and/or guide said one or more cutting blades along any of a variety of different cut patterns, and
wherein said actuator selectively positions said one or more cutting blades between an operative position and an inoperative position.

20. The rotary trimmer of claim 19, wherein said handle is an arcuate pad extending substantially over said blade carriage.

21. The rotary trimmer of claim 20, wherein said actuator slidingly positions said one or more cutting blades along a linear path between an inoperative position and an operative position.

22. The rotary trimmer of claim 21, wherein said linear path is oblique with respect to a cutting surface when in operative use.

23. The rotary trimmer of claim 19, wherein said handle is elongated and has a hand gripping portion and a neck connecting said hand gripping portion to said blade carriage.

24. The rotary trimmer of claim 23, wherein said actuator slidingly positions said one or more cutting blades along a linear path between an inoperative position and an operative position.

25. The rotary trimmer of claim 24, wherein said linear path is oblique with respect to a cutting surface when in operative use.

26. The rotary trimmer of claim 24, wherein said actuator is a trigger in said neck of said handle.

27. The rotary trimmer of claim 24, wherein said actuator selectively interacts with a blade mounting element in said blade carriage to bring about said positioning of said one or more cutting blades.

28. The rotary trimmer of claim 19, wherein said blade carriage has a connector enabling said blade carriage to be selectively and operatively connected to different tools.

29. The rotary trimmer of claim 28, wherein said different tools are selected from a group consisting of a rail operatively connected to a cutting board and a hand-held tool with an elongated handle.

30. A rotary trimmer comprising:
one or more cutting blades;
a blade carriage for carrying said one or more blades, said blade carriage having a connector; and
a rail having one or more guide grooves, said rail being operatively connected to a cutting board,
wherein said connector enables said blade carriage to be selectively and operatively connected to said rail via said one or more guide grooves, and wherein said blade carriage enables a user to effectively manipulate or guide said one or more cutting blades along any of a variety of different cut patterns.

31. The rotary trimmer of claim 30, wherein said connector has one or more tabs for engagement with said one or more guide grooves.

32. The rotary trimmer of claim 31, wherein said connector has one or more elements to selectively secure said blade carriage to one or more matching fastening elements of said hand-held tool.

33. A cutting blade for use with a rotary trimmer comprising:
a body having a cutting edge with a predefined cutting profile; and
a planar side portion of said body with one or more apertures therein, said body also having a transition portion between said predefined cutting edge and said planar side portion,
wherein said profiled cutting edge is equally extensive with respect to said planar side portion of said body.

34. The cutting blade of claim 33, wherein said cutting edge is symmetrically tapered.

34. The cutting blade of claim 33, wherein said one or more apertures include a large central aperture and one or more small peripheral apertures about said central aperture.

35. The cutting blade of claim 33, wherein said one or more apertures are appropriately sized to engage a mounting hub of said rotary trimmer.
